(19) United States
(12) Patent Application Publication
(10) Pub. No.: US 2010/0141009 A1
(43) Pub. Date: Jun. 10, 2010

(54) VEHICLE SEAT STRUCTURE

(76) Inventors: Eckhard Kirch, Bann (DE); Heiko Utsch, Kaiserlautern (DE)

Correspondence Address: MCGLEW & TUTTLE, PC, P.O. BOX 9227, SCARBOROUGH STATION, SCARBOROUGH, NY, 10510-9227, US

(21) Appl. No.: 12/301,487

(22) PCT Filed: Jul. 6, 2007
(86) PCT No.: PCT/DE07/01228

§ 371 Date: Nov. 19, 2008

(30) Foreign Application Priority Data
Jul. 6, 2007 (DE) 10 2006 033 156.7

(51) Int. Cl. B60N 2/68; B23K 20/10

(52) U.S. Cl. 297/452.18; 228/110.1; 228/1.1

(57) ABSTRACT

A vehicle seat (1) structure (10) is provided in which at least two structural parts (12, 14) are connected to each other at least at one contact point (P) by means of ultrasonic welding.

### CROSS REFERENCE TO RELATED APPLICATIONS

This application is a United States National Phase application of International Application PCT/DE2007/001228 and claims the benefit of priority under 35 U.S.C. §119 of German Patent Application DE 10 2006 033 156.7 filed Jul. 18, 2006, the entire contents of which are incorporated herein by reference.

### FIELD OF THE INVENTION

The invention relates to a vehicle seat structure with at least two structural parts which are connected to one another.

### BACKGROUND OF THE INVENTION

Known supporting structures of vehicle seats have structural parts which are stamped from thin sheet steel and are welded to one another, for example by means of laser welding.

### SUMMARY OF THE INVENTION

An object of the invention is to improve a structure of the aforementioned type.

This object is achieved according to the invention by a structure comprising a first vehicle seat structural part and a second vehicle seat structural part. The first structural part is connected to the second vehicle seat structural part by means of ultrasonic welding at a contact point to provide an ultrasonically formed weld connection at the contact point.

Vehicle seat structures are intended, on the one hand, to comprise materials having a high degree of weight-specific rigidity, strength and energy absorption, in order to increase the safety of the passenger and, on the other hand, to use lightweight materials in order to reduce the overall weight. The manufacture of structures which are optimized in terms of load and weight is achieved by combining different materials, i.e. hybrid structures are produced.

The two materials of the hybrid structure may be connected to one another. Bonding, riveting, screwing, clinch riveting and welding, for example, are considered as connection techniques. Welding two metals may take place without pressure (melt welding), for example in metal active gas welding or in laser welding, by means of which in structures made of steel it is possible that the cost and the weight are optimized, or the welding may be carried out by using pressure (pressure welding), for example in roll seam welding, projection welding, spot welding or—according to the invention—ultrasonic welding. In ultrasonic welding, the parts are connected to one another in the plastic but unmelted state.

The advantages of ultrasonic welding relative to other welding methods are that no weld spatter occurs, a connection of aluminum/aluminum alloys and steel and/or (glass) fiber-reinforced plastics is possible, there is a lower heat input and thus less distortion occurs, multiple spot welding is possible and thus shorter process times occur, no holding time is necessary for curing, no welding gap is present as a result of the method, the process monitoring is easy and the geometry of the welded connection may be designed to be load-compatible.

As at least two of the structural parts consist of different materials and are connected to one another by means of ultrasonic welding at least one contact point, a low-weight hybrid structure is provided which is produced cost-effectively and which provides the necessary strength. The materials may thus, on the one hand, be aluminum/aluminum alloys and, on the other hand, steel. However, other materials are also possible, for example glass fiber-reinforced plastics, or other fiber-reinforced plastics, for example in combination with one of the aforementioned metals. Two or more structural parts may be simultaneously connected to one another. The simultaneous connection at a plurality of contact points is possible, for example by means of a plurality of, possibly different, sonotrodes of an ultrasonic welding device.

The structure is preferably the supporting structure of a seat-back of a vehicle seat, but may also be the supporting structure of a seat part. Preferably, base sheets and side members are connected to one another. For example, side parts and cross members could also be connected to one another.

The invention is described in more detail hereinafter with reference to an embodiment with a modification shown in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of an embodiment according to the invention;

FIG. 2 is a schematic side view of a vehicle seat including the embodiment according to the invention;

FIG. 3 is a sectional view through the embodiment along the line III-III in FIG. 1;

FIG. 4 is a sectional view through a modification of the embodiment of FIG. 1;

FIG. 5 is a partially sectioned and schematic view of a known ultrasonic welding device;

FIG. 6 is a schematic partial view of the ultrasonic welding device with a tilted sonotrode and corresponding workpieces;

FIG. 7 is a further schematic partial view corresponding an embodiment of the workpieces;

FIG. 8 is a schematic partial view of the ultrasonic welding device with sonotrodes arranged alternately;

FIG. 9 is a side view of device shown in FIG. 8; and

FIG. 10 is a perspective partial view of the ultrasonic welding device with sonotrodes of different types arranged offset relative to one another.

### DESCRIPTION OF THE PREFERRED EMBODIMENTS

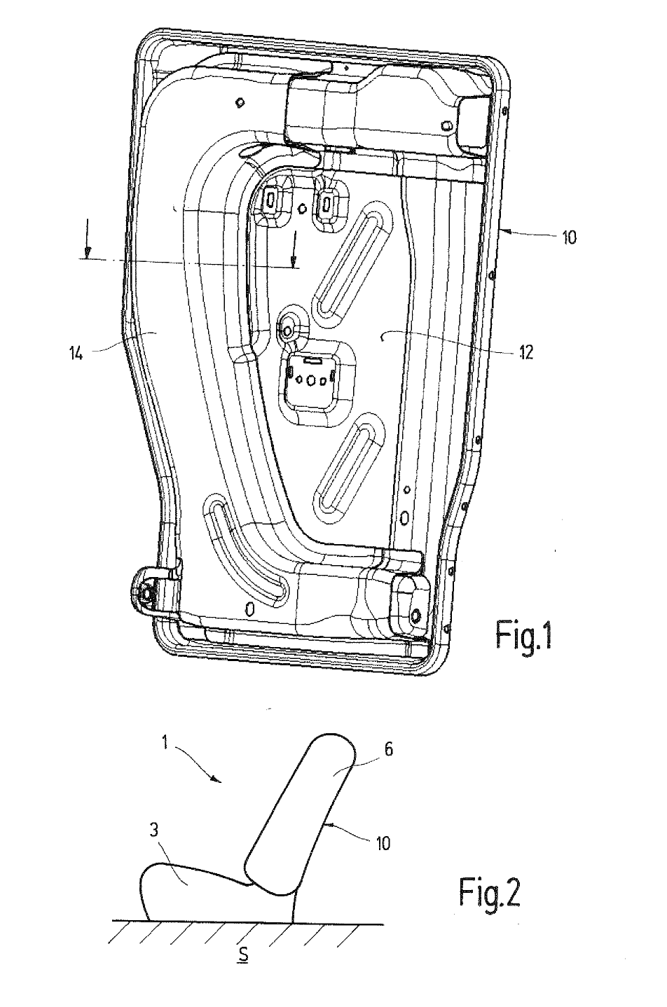

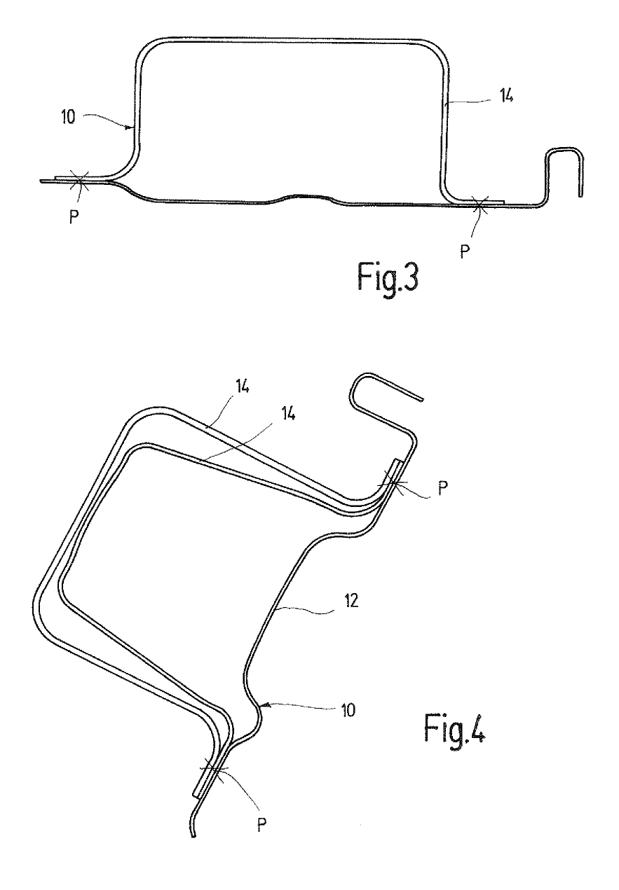

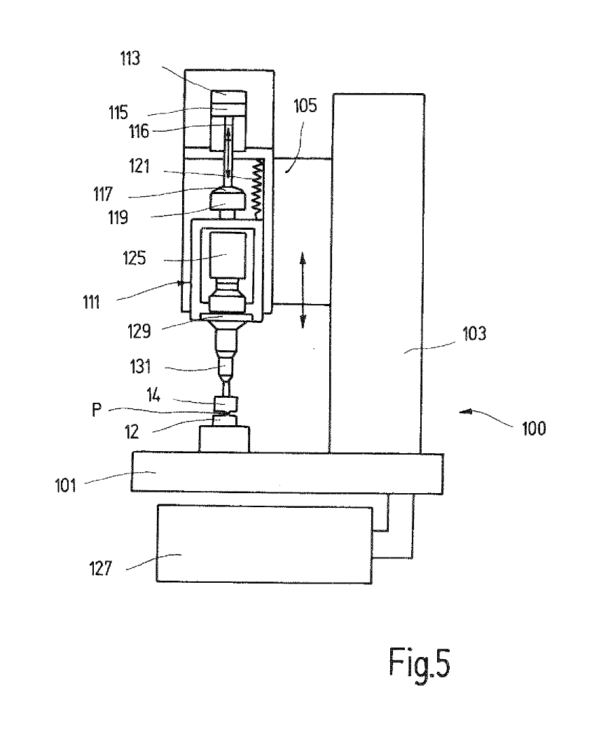

Referring to the drawings in particular, FIG. 2, a vehicle seat 1 of a motor vehicle has a seat part 3, which is connected to the vehicle structure S of the motor vehicle, and a seat-back 6 which is pivotable relative to the seat part 3, which is articulated on both sides on the seat part 3. To use the seat, the seat-back 6 is locked to the seat part 3 or to the vehicle structure S. In the embodiment, the vehicle seat 1 is a rear seat system with a split backrest, i.e. the seat-back 6 is one third or two thirds of the aforementioned split backrest.

The seat-back 6 has a supporting structure 10 which comprises as structural parts a base sheet 12 and at least one side member 14. The base sheet 12 is substantially planar. It may comprise beads for the reinforcement thereof. The side member 14 has a substantially U-shaped profile. In the present case, a plurality of side members 14 are connected together to form a peripheral frame, partially also formed integrally relative to one another. The present side members 14 are arranged on the front face of the base sheet 12—facing the occupant when the seat is used—and connected thereto—by forming box sections. The structure 10 thus formed is also upholstered on the front face of the base sheet 12. The rear face of the base sheet 12 directly faces the luggage compartment, possibly simply painted or covered, and may extend the loading floor when the seat-back 4 is pivoted forward.

In the embodiment, the base sheet 12 consists of aluminum, more specifically in the present case of aluminum sheet Al Mg 4.5 Mn, at a thickness of for example 0.7 mm or 1.0 mm. In the embodiment, the side member 14 consists of steel, more specifically in the present case sheet steel at a thickness of 0.7 mm. The side member 14 and the base sheet 12 are ultrasonically welded to one another, i.e. connected by means of ultrasonic welding.

An ultrasonic welding device 100 known per se, has an anvil 101 (base plate), an upright 103 fixed relative to the anvil 101 and a slide 105 which is movable, in the present case vertically movable, relative to the upright 103. The slide 105 comprises a guide and receiver for a feeder unit 111 which is mounted movably, in particular parallel, relative to the slide 105 in the guide and receiver of the slide 105. The feeder unit 111 is thus movable relative to the anvil 101. The feeder unit 111 is acted upon by a pneumatic cylinder 113 supported on the slide 105, the piston 115 thereof acting by means of a piston rod 116 and a damping member 117, as well as a force transducer 119 in series, on the feeder unit 111, in the present case on the upper face thereof. A restoring spring 121 pretensions the feeder unit 111 in the direction of the pneumatic cylinder 113.

The feeder unit 111 encompasses a converter 125 which converts a high voltage generated by a generator 127 into ultrasound. The ultrasound is transmitted by a booster 129 to one or more sonotrodes 131 at the tip of the feeder unit 111, i.e. in the present case on the underside thereof. The sonotrodes 131 are positioned on the one workpiece, the other workpiece bearing against the anvil 101, i.e. the workpieces being arranged between the sonotrodes 131 and the anvil 101. The pneumatic cylinder 113 creates a static pressure, so that the two workpieces bear against one another under pretension at the contact points P, monitored and controlled by the force transducer 119.

The ultrasound introduced via the sonotrodes 131 into the upper workpiece, heats the materials (steel/aluminum) at the pretensioned contact points P to approximately 300°-400° C. With this physical contact an atomic interaction is produced between the materials, aluminum atoms diffusing into the steel surface.

By means of such an ultrasonic welding device 100 the side member 14 is welded to the base sheet 12. The welded connection is arranged in its size and contour such that, relative to its strength, the required energy absorption of the structure 10 is ensured. For reducing the processing times, a plurality of sonotrodes 131 simultaneously weld a plurality of contact points P positioned in one plane, between the side member 14 and the base sheet 12. In a modified embodiment, it is also possible to weld simultaneously two interlocking side members 14 of different profiles to the base sheet 12, i.e. to carry out a triple weld. The sonotrodes 131 may vary in their dimensioning and/or construction (type). The welded seam may be dimensioned differently depending on the loads to be received, which also may be achieved by the different sonotrodes 131. The possible basic shapes of the welded surfaces at the contact points P may, in particular, be annular, square or circular. According to requirements, a plurality of feeder units 111 and/or a plurality of slides 105 may also be provided.

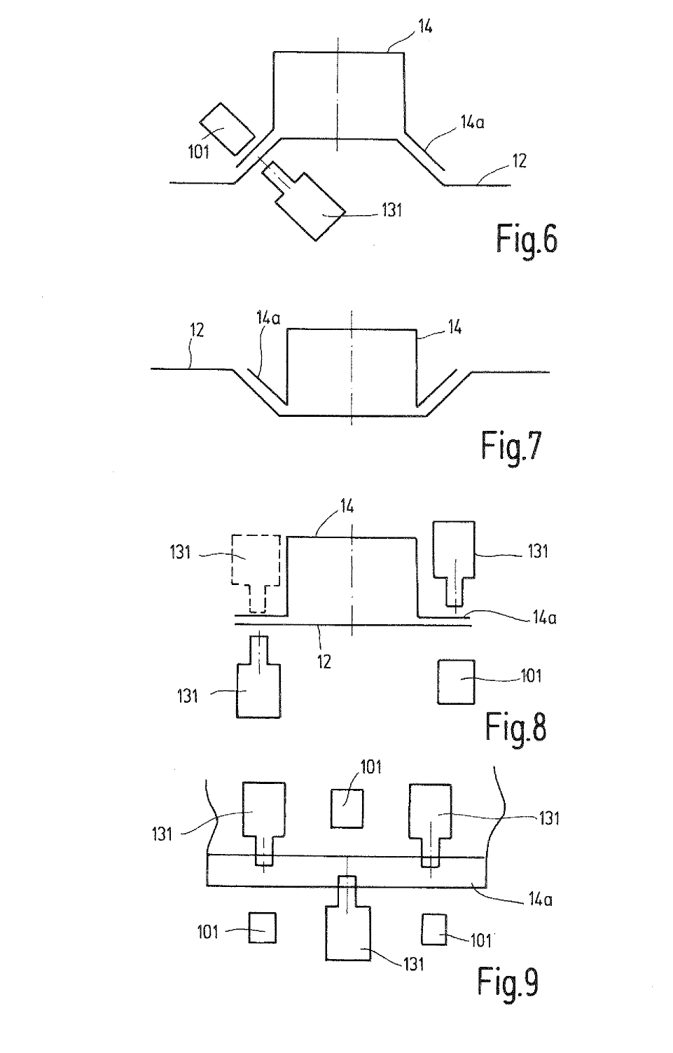

According to the design of the ultrasonic welding device 100, when inserting the workpieces, the upright 103 may act as a limit for the base sheet 12, i.e. define the maximum possible distance from one contact point P to the edge of the base sheet 12. So as to reach also regions in the center of the base sheet 12, the sonotrode 131 may be tilted, i.e. relative to the upright 103 and to the direction of movement of the slide 105. Preferably, the entire feeder unit 111 is tilted relative to the direction of movement of the slide 105. Accordingly, the anvil 101 and the workpieces are adapted thereto. A region of the anvil 101 is tilted at the same angle. The side member 14 has a correspondingly bent-back welding flange 14a and the base sheet 12 is correspondingly formed. FIG. 6 shows a partial view of a thus modified ultrasonic welding device 100. Depending on the spatial relationships, it may be expedient to allow the welding flange 14a to project from the side member 14 not at an obtuse angle as in FIG. 6 but at an acute angle, as shown in FIG. 7. An alternate arrangement of these two concepts is also possible along an axis perpendicular to the drawing plane.

In order to reduce the distance between two contact points P, it is advantageous to supply the associated sonotrodes 131 alternately from different sides relative to the plane through the contact points P, for example alternately from above and from below, as shown in FIG. 8 and also in side view in FIG. 9. The anvil 101 has correspondingly alternately arranged regions. Some of the sonotrodes 131 and regions of the anvil 101 are thus connected to the feeder unit 111, the others are fixed. A combination is also possible with the tilted sonotrodes 131 according to FIGS. 6 and/or 7.

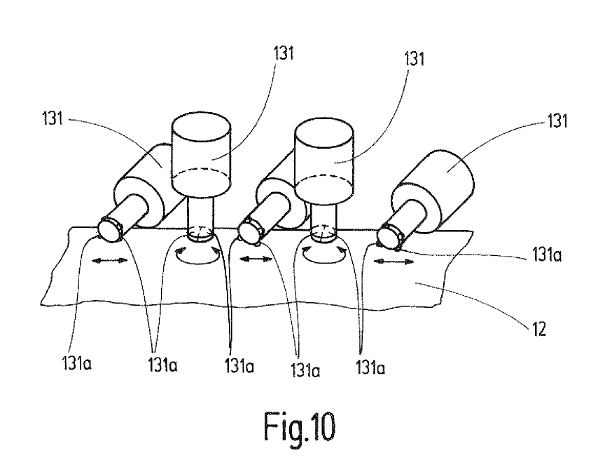

In FIG. 10 it is shown how a plurality of sonotrodes 131 of different types are arranged offset by 90° relative to one another. In this case, two sonotrodes 131 of the “torsion sonotrode” type are shown which rotate during welding about their longitudinal axis and in the present case have two (for example cam-like) active surfaces 131a on the front face. These two sonotrodes 131 are positioned with their longitudinal axis perpendicular to the plane of the base sheet 12. Moreover, three sonotrodes 131 of the “linear lambda sonotrode” type are shown, which during welding are displaced in a linear manner perpendicular to their longitudinal axis, and in the present case have four (for example cam-like) active surfaces 131a in the radial direction, of which however only two are in use at the same time (the other two active surfaces serve as a back-up in case of wear). These three sonotrodes 131 are arranged (with frame support) in a plane parallel to the base sheet 12 and move within this plane perpendicular to their longitudinal axis. Viewed along the side member 14, one of the three sonotrodes 131 of the “linear lambda sonotrode” type is arranged between the two sonotrodes 131 of the “torsion sonotrode” type, and this group of three is arranged between the two other sonotrodes 131 of the “linear lambda sonotrode” type. The directions of movement of the sonotrodes 131 are indicated by arrows in FIG. 10. By means of the five sonotrodes 131 with the two active surfaces 131a, which are present during use, ten welding points may be produced simultaneously (and at close intervals). Preferably, the intervals between the five sonotrodes 131 are the same, so that five evenly spaced-apart pairs of two respective welding points are produced at the ten contact points P.

While specific embodiments of the invention have been shown and described in detail to illustrate the application of the principles of the invention, it will be understood that the invention may be embodied otherwise without departing from such principles.

1. A vehicle seat structure comprising:
a first vehicle seat structural part;
a second vehicle seat structural part, said first vehicle seat structural part being connected to said second vehicle seat structural part by means of ultrasonic welding at a contact point to provide an ultrasonically formed weld connection at said contact point.

2. A structure as claimed in claim 1, wherein said first vehicle seat structural part and said second vehicle seat structural part consist of different materials.

3. A structure as claimed in claim 2, wherein at least one of said first vehicle seat structural part and said second vehicle seat structural part consists of aluminum/aluminum alloy and at least one other of said first vehicle seat structural part and said second vehicle seat structural part consists of steel.

4. The structure as claimed in claim 2, further comprising: a third vehicle seat structural part wherein one of said first vehicle seat structural part and said second vehicle seat structural part and said third vehicle seat structural part is made of aluminum/aluminum alloy and two other of said first vehicle seat structural part and said second vehicle seat structural part and said third vehicle seat structural part is made of steel, with said first vehicle seat structural part and said second vehicle seat structural part and said third vehicle seat structural part connected to one another by means of a triple weld at said contact point (P).

5. The structure as claimed in claim 1, wherein the structure is the supporting structure of a seat-back of a vehicle seat.

6. The structure as claimed in claim 5, wherein one of said first vehicle seat structural part and said second vehicle seat structural part is a base sheet and the other of said first vehicle seat structural part and said second vehicle seat structural part is a side member.

7. The structure as claimed in claim 1, wherein the structural parts are connected to one another at a plurality of contact points, said contact points being located in one plane.

8. (canceled)

9. A method for connecting at least two structural parts of a supporting structure, the method comprising the steps of:
providing a first vehicle seat structural part;
providing a second vehicle seat structural part; and
connecting the two structural parts to one another at least one contact point by means of ultrasonic welding.

10. An ultrasonic welding device, comprising:
an anvil; and
a feeder unit which is movable relative to the anvil and which may be subjected to a controlled pretensioning;
a sonotrode, the workpieces to be welded being arranged between the anvil and the sonotrode, wherein the ultrasonic welding device connects together at least two structural parts of a supporting structure of a motor vehicle seat including a first vehicle seat structural part and a second vehicle seat structural part, at least one contact point by means of ultrasonic welding.

11. A ultrasonic welding device as claimed in claim 10, further comprising at least one additional sonotrode wherein a plurality of sonotrodes are provided in order to connect simultaneously the structural parts to one another at a plurality of contact points.

12. The ultrasonic welding device as claimed in claim 11, wherein relative to a plane through at least two contact points at least two sonotrodes are arranged alternately on different sides.

13. The ultrasonic welding device as claimed in claim 11, further comprising an upright and a slide connected to said upright wherein at least one of the sonotrodes and/or the feeder unit is tilted relative to the upright and/or the direction of movement of the slide is movable relative to the upright.

14. The ultrasonic welding device as claimed in claim 10, further comprising at least one additional sonotrode wherein a plurality of sonotrodes of different types are arranged offset by 90° relative to one another.

15. The ultrasonic welding device as claimed in claim 14, wherein said plurality of sonotrodes include torsion sonotrodes and linear lambda sonotrodes wherein the torsion sonotrodes and the linear lambda sonotrodes are arranged alternately.

16. A structure as claimed in claim 2, wherein at least one of said first vehicle seat structural part and said second vehicle seat structural part consists of a fiber-reinforced plastic and at least one other of said first vehicle seat structural part and said second vehicle seat structural part consists of steel.

17. A method as claimed in claim 9, wherein:
said step of connecting includes providing an ultrasonic welding device having an anvil, a feeder unit which is movable relative to the anvil and which may be subjected to a controlled pretensioning, and at least one sonotrode whereby the workpieces to be welded are arranged between the anvil and the sonotrode and wherein the ultrasonic welding device connects together the first vehicle seat structural part and the second vehicle seat structural part at the at least one contact point by means of ultrasonic welding.

18. A method as claimed in claim 17, wherein the ultrasonic welding device further comprises at least one additional sonotrode wherein a plurality of sonotrodes are provided and act to simultaneously connect the structural parts to one another at a plurality of contact points.

19. A method as claimed in claim 17, wherein relative to a plane through at least two contact points at least two sonotrodes are arranged alternately on different sides.

20. A method as claimed in claim 17, wherein the ultrasonic welding device further comprises an upright and a slide connected to said upright wherein at least one of the sonotrodes and/or the feeder unit is tilted relative to the upright and/or the direction of movement of the slide which is moved relative to the upright.

21. A method as claimed in claim 17, wherein the ultrasonic welding device further comprises at least one additional sonotrode wherein a plurality of sonotrodes of different types are arranged offset by 90° relative to one another including torsion sonotrodes and linear lambda sonotrodes with the torsion sonotrodes and the linear lambda sonotrodes arranged alternately.
